(19) United States
(12) Patent Application Publication
(10) Pub. No.: US 2026/0280269 A1
(43) Pub. Date: Sep. 17, 2026

(54) DIGITAL EMERGENCY ELECTRIC SAFETY CONTROL SYSTEM

(71) Applicant: TECHNOMIRAI CO., LTD., Tokyo (JP)

(72) Inventor: Kazuo MIWA, Tokyo (JP)

(73) Assignee: TECHNOMIRAI CO., LTD., Tokyo (JP)

(21) Appl. No.: 19/675,871

(22) Filed: May 13, 2026

Related U.S. Application Data
(63) Continuation of application No. PCT/JP2024/034662, filed on Sep. 27, 2024.

(30) Foreign Application Priority Data
Nov. 17, 2023 (WO) PCT/JP2023/041534

(51) Int. Cl. H02H 3/08

(52) U.S. Cl. CPC H02H 3/08

(57) ABSTRACT

A system prevents occurrence of an electrical accident leading to a fire or the like in advance in a power device in which a power-source-side electric path from a power-source side is electrically connected to a load-side electric path toward a load, via electrical equipment or the like disposed in a housing, and further prevents occurrence of an accident in advance such as damage of various power/electrical equipment and devices to which the load-side electric path is connected. By connecting an instantaneous alternating current value detection device to the load-side electric path, the system detects an instantaneous current value that is a current value flowing through the load-side electric path in an instantaneous time, compares the detected instantaneous current value with a preset allowable current value range, and issues a necessary alert and interrupts power supply when necessary.

### CROSS-REFERENCE TO RELATED APPLICATIONS

This application is a “by-pass” continuation application under 35USC 111 (a) based on International Application PCT/JP2024/034662, filed Sep. 27, 2024, also this application claims priority to and the benefit of International Application PCT/JP2023/041534, filed Nov. 17, 2023, under the Paris Convention, which is incorporated herein by reference in its entirety.

### BACKGROUND

### Technical Field

The present invention relates to a system for preventing occurrence of an electrical accident leading to a fire or the like in advance in a power device in which a power-source-side electric path from a power-source side is electrically connected to a load-side electric path toward a load, via electrical equipment or the like disposed in a housing, and further prevents occurrence of an accident in advance such as damage of various power/electrical equipment and devices to which the load-side electric path is connected.

The applicant of the present application has already implemented a digital electric safety control system (JP 6732278 B1), named “DESCON”, which is a system for preventing occurrence of an electrical accident leading to a fire in advance, when a power-source-side electric path from a power-source side is electrically connected to a load-side electric path toward a load that operates by receiving power supply, such as lighting equipment/devices, air conditioning equipment/devices, freezing and refrigeration equipment/devices, and production equipment/devices, via a power device such as power receiving and transforming equipment, a switchboard, a distribution board, a lighting panelboard, a power panelboard, a control panel, and a junction box that are provided with electrical equipment such as a main breaker and a leakage breaker.

The applicant of the present application has proposed a “digital electric safety control system” (JP 6836234 B1) which is a system for preventing occurrence of an electrical accident leading to a fire or the like in advance in a power device, such as a switchboard, a distribution board, a lighting panelboard, a power panelboard, a control panel, and a junction box in which a power-source-side electric path from a power-source side is electrically connected to a load-side electric path toward a load, via electrical equipment or the like disposed in a housing, and further prevents occurrence of an accident in advance such as damage of various power/electrical equipment and devices to which the load-side electric path is connected.

The applicant of the present application has proposed a system, named a “DESCON operation safety system” (JP 6991636 B1), that can automatically perform ON/OFF switching of each of a plurality of loads to which a load-side electric path is connected, automatically check a meter for a power usage amount in the load and automatically calculate the power usage amount to save labor, and further prevents occurrence of an electrical accident leading to a fire in advance by detecting bolt looseness in a bolt screw tightening connection portion in a power device, insufficient insertion into a receptacle, and leakage due to dust adhesion in the bolt screw tightening connection portion.

### SUMMARY

The applicant of the present application has implemented the “digital electric safety control system” patented in JP 6732278 B1, named “DESCON”, and evolved the “digital electric safety control system” of JP 6732278 B1 to obtain a patent for the “digital electric safety control system” of JP 6836234 B1. Further, the applicant of the present application has obtained a patent for the “DESCON operation safety system” in JP 6991636 B1, which is an invention obtained by evolving the “digital electric safety control system” patented in JP 6732278 B1 and the “digital electric safety control system” of JP 6836234 B1, and has completed the “digital emergency electric safety control system” according to the invention of the present application by further conducting studies.

The applicant of the present application is preparing to provide the “digital emergency electric safety control system” according to the invention of the present application to society under the name of “DESCON emergency system”.

The invention according to the “digital emergency electric safety control system” according to the invention of the present application, that is, the “DESCON emergency system” is to connect an instantaneous alternating current value detection device to a load-side electric path, detect an instantaneous current value that is a current value flowing through the load-side electric path in an instantaneous time, compare the detected instantaneous current value with a preset allowable current value range, and issue a necessary alert and interrupt power supply when necessary.

One of the invention of present application may be exemplified as follows.

A digital emergency electric safety control system including:
a power device in which a power-source-side electric path that is an electric path from a power-source side is electrically connected to a load-side electric path that is an electric path toward a load, via electrical equipment disposed in a housing;
an instantaneous current value detection device that is connected to the electric path and detects an instantaneous alternating current value or an instantaneous direct current value each of which is an instantaneous current value flowing through the electric path in an instantaneous time;
an instantaneous current value determination device that compares the detected instantaneous current value with a preset allowable current value range;
a first alert notification information output unit that outputs alert notification information together with information for specifying the power device related to the housing, to an administrator terminal used by an administrator who manages the power device and an operator terminal owned by an operator who is in charge of management of the power device, when the instantaneous current value determination device determines that the instantaneous current value is within a predetermined alert trigger range;
a power supply automatic interruptibility determination unit that determines, when the instantaneous current value determination device determines that the instantaneous current value is within a predetermined power supply interruption range, whether or not the load supplied with a current having the instantaneous current value determined to be within the predetermined power supply interruption range is an automatically interruptible power supply load;
a first power supply interruption device that automatically interrupts power supply to the load determined as an automatically interruptible power supply load by the power supply automatic interruptibility determination unit, and
a second power supply interruption device that interrupts, when the power supply automatic interruptibility determination unit determines that the load is not an automatically interruptible power supply load, power supply to a load device controller controlling the load determined as not being an automatically interruptible power supply load, and then automatically interrupts power supply to the load.

### BRIEF DESCRIPTION OF DRAWINGS

FIG. 1 is a diagram illustrating a part of an outline of an overall configuration of a digital emergency electric safety control system of the present invention, and is a conceptual diagram, in which a part thereof is omitted, illustrating a state in which a DESCON system central device including a server device including a computer is connected with a high-voltage power reception board and a capacitor board of a cubicle to be managed and controlled, so as to enable mutual communication of information via a wired or wireless network such as the Internet and a dedicated line;

FIG. 2 is a conceptual diagram illustrating an example of a configuration of a tracking detection system in the digital emergency electric safety control system of the present invention;

FIG. 3 is a conceptual diagram illustrating an example of another configuration of the tracking detection system in the digital emergency electric safety control system of the present invention;

FIG. 4 is a flowchart illustrating an example of a flow in which an instantaneous current value flowing through an electric path is detected by the instantaneous current value detection device, and alert transmission to an operator and power source interruption to electrical equipment (load) are performed on the basis of a detection result in the digital emergency electric safety control system of the present invention;

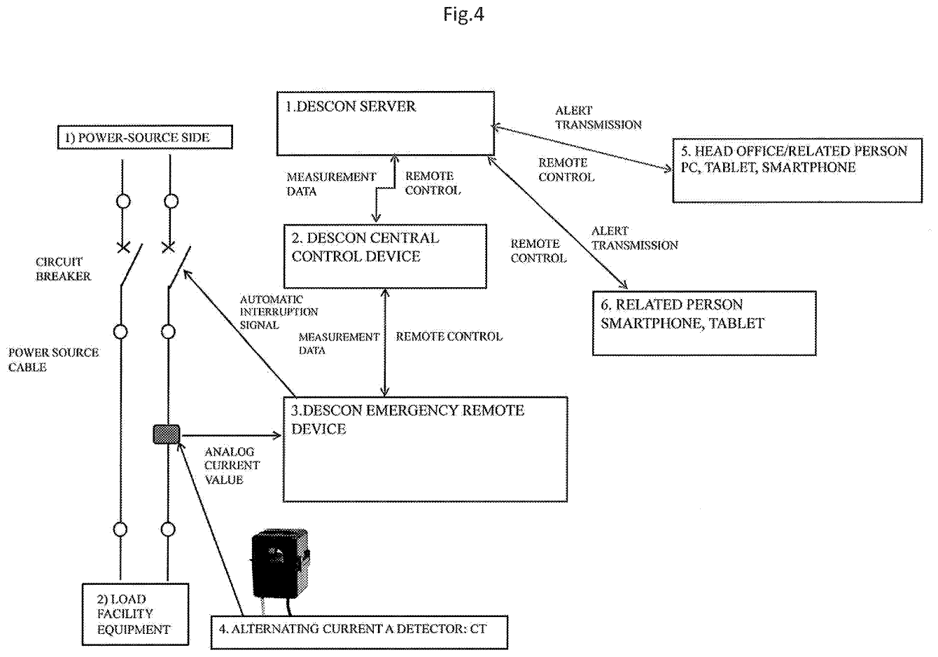

FIG. 5 is a conceptual diagram illustrating an example of a configuration of a smart breaker system in the digital emergency electric safety control system of the present invention;

FIG. 6 is a flowchart illustrating an example of a tracking detection function in the digital emergency electric safety control system of the present invention;

FIG. 7 is a flowchart illustrating an example of a Joule heat detection function in the digital emergency electric safety control system of the present invention;

FIG. 8 is a flowchart illustrating an example of an overcurrent detection function in the digital emergency electric safety control system of the present invention;

FIG. 9 is a flowchart illustrating an example of a leakage current detection function in the digital emergency electric safety control system of the present invention;

### DETAILED DESCRIPTION

A digital emergency electric safety control system of the present invention, that is, a DESCON emergency system includes a power device, an instantaneous current value detection device, an instantaneous current value determination device, a first alert notification information output unit, a power supply automatic interruptibility determination unit, a first power supply interruption device, a second power supply interruption device, a housing internal temperature information acquisition unit, an electric path temperature information acquisition unit, a housing internal temperature monitoring unit, an electric path temperature monitoring unit, a second alert notification information output unit, and a third alert notification information output unit.

Hereinafter, in the present specification and the drawings, the “digital emergency electric safety control system” may be referred to as a “DESCON emergency system” or a “DESCON”.

In the power device, a power-source-side electric path which is an electric path from a power-source side is electrically connected to load-side electric paths which are a plurality of electric paths branched from the power-source-side electric path and directed to a plurality of loads, in a housing. First electrical equipment is interposed on the power-source-side electric path in the housing, and second electrical equipment is interposed on each of the plurality of load-side electric paths in the housing. The first electrical equipment interposed on the power-source-side electric path and the plurality of pieces of second electrical equipment interposed on the plurality of load-side electric paths are both disposed in the housing.

Examples of such a power device include, for example, power receiving and transforming equipment, a switchboard, a distribution board, a lighting panelboard, a power panelboard, a control panel, a remote control panel, and a junction box for branch wiring connection of an extension cord or a wiring line between devices/instruments and the switchboard, a distribution board, or the like.

The first electrical equipment is disposed in a housing constituting the above-described power device, and electrically connects between the power-source-side electric path from the power-source side and the load-side electric path toward the load. Examples of the first electrical equipment include a main breaker and a leakage breaker.

The plurality of pieces of second electrical equipment are circuit switches of a type different from the main breaker, the leakage breaker, and the like described above. Examples of the circuit switches include a magnet switch, a power relay, and a solid state relay.

Examples of the load toward which the load-side electric path is directed include power/electric apparatuses and devices that operate by receiving power supply, such as a prime mover, an elevator, air conditioning equipment, ventilation equipment, lighting equipment, a refrigerating/freezing case, a refrigerator/freezer, a measuring instrument, a computer device, a monitoring camera, a medical device, and a communication apparatus, and include power/electric apparatuses and devices disposed and used regardless of whether inside or outside a building, power/electric apparatuses and devices and communication apparatuses and devices disposed and used in vehicles and moving means such as trains, cars, airplanes, and ships, and receptacles to which these are connected.

These loads are respectively connected to a distal end side of the plurality of load-side electric paths.

The instantaneous current value detection device is connected to the electric path described above, and detects an instantaneous alternating current value or an instantaneous direct current value each of which is an instantaneous current value flowing through the electric path in an instantaneous time. For example, the instantaneous current value detection device is connected to the load-side electric path described above, and detects an instantaneous alternating current value or an instantaneous direct current value each of which is an instantaneous current value flowing through the load-side electric path in an instantaneous time.

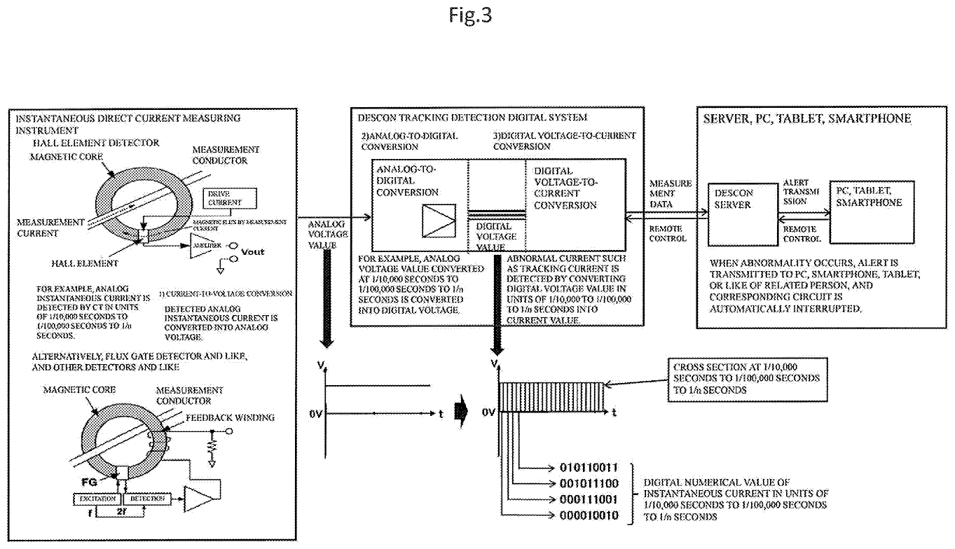

As the instantaneous current value detection device, a current sensor using an instrument current transformer called a current transformer (CT) or an instantaneous direct current measuring instrument illustrated in FIG. 3 using a Hall element can be adopted.

Units of the instantaneous time in the detection in the instantaneous time are, for example, 1/12000 seconds=83 microseconds, and can be freely set between 1/50,000 seconds (=20 μsec) and 1/100,000 seconds (=10 μsec). In addition, within this range, the instantaneous time can also be set in microseconds according to a performance of a computer (PC) constituting the DESCON emergency system.

Setting the units of the instantaneous time in the detection in the instantaneous time in microseconds between 1/50,000 seconds (=20 μsec) and 1/100,000 seconds (=10 μsec) is advantageous for detecting a risk of occurrence of a tracking phenomenon earlier and taking necessary measures such as power source interruption before the tracking phenomenon occurs.

The instantaneous current value determination device performs processing of comparing the detected instantaneous current value with a preset allowable current value range.

For example, the instantaneous current value determination device determines that an instantaneous current value corresponding to 12 to 17 times a normal current value on the electric path where the instantaneous current value has been detected is within an alert trigger range to be described later.

Further, for example, the instantaneous current value determination device determines that an instantaneous current value in a range exceeding 17 times and up to 22 times the normal current value on the electric path where the instantaneous current value has been detected is within a power supply interruption range to be described later.

When the instantaneous current value determination device determines that the instantaneous current value is within a predetermined alert trigger range, the first alert notification information output unit performs processing of outputting alert notification information together with information for specifying the power device related to the housing, to an administrator terminal used by an administrator who manages the power device and an operator terminal owned by an operator who is in charge of management of the power device.

The administrator terminal can include a personal computer or the like including an image information display unit such as a monitor. The operator terminal can include a mobile terminal such as a smartphone in which an application for operating the system of the present invention is downloaded.

The administrator terminal and the operator terminal are connected via a communication network such as the Internet or a dedicated line, so as to enable mutual communication of information with a computer system including a server computer or the like constituting the digital emergency electric safety control system of the present invention, that is, the DESCON emergency system.

When the instantaneous current value determination device determines that the instantaneous current value is within a predetermined power supply interruption range, the power supply automatic interruptibility determination unit performs processing of determining whether or not the load supplied with a current having the instantaneous current value determined to be within the predetermined power supply interruption range is an automatically interruptible power supply load.

The first power supply interruption device performs processing of automatically interrupting power supply to the load determined as an automatically interruptible power supply load by the power supply automatic interruptibility determination unit.

When the power supply automatic interruptibility determination unit determines that the load is not an automatically interruptible power supply load, the second power supply interruption device performs processing of interrupting power supply to a load device controller controlling the load determined as not being an automatically interruptible power supply load, and then automatically interrupting power supply to the load.

The housing internal temperature information acquisition unit performs processing of constantly detecting a temperature in the housing described above, and outputting, as digital information, housing internal temperature information that is information regarding the detected temperature in the housing, together with information for specifying the power device related to the housing.

The electric path temperature information acquisition unit including a digital temperature sensor, a digital thermometer, and the like performs processing of constantly detecting a temperature of the electric path described above, and outputting, as digital information, electric path temperature information that is information regarding the detected temperature of the electric path, together with information for specifying the electric path where the temperature has been detected.

The housing internal temperature monitoring unit performs processing of comparing the temperature in the housing acquired by the housing internal temperature information acquisition unit with a housing internal monitoring temperature that is preset.

The electric path temperature monitoring unit performs processing of comparing the temperature of the electric path acquired by the electric path temperature information acquisition unit with an electric path monitoring temperature that is preset.

When the housing internal temperature monitoring unit determines that the temperature in the housing acquired by the housing internal temperature information acquisition unit exceeds the housing internal monitoring temperature, the second alert notification information output unit performs processing of outputting alert notification information to the administrator terminal and the operator terminal, together with information for specifying the power device related to the housing.

When the electric path temperature monitoring unit determines that the temperature of the electric path acquired by the electric path temperature information acquisition unit exceeds the electric path monitoring temperature, the third alert notification information output unit performs processing of outputting alert notification information to the administrator terminal and the operator terminal, together with information for specifying the electric path having the temperature determined to exceed the electric path monitoring temperature.

The digital emergency electric safety control system of the present invention, that is, the DESCON emergency system includes a computer system including a server computer and the like. Although not illustrated, the computer system includes a computer including: a CPU that performs control such that various functions of the system of this embodiment are implemented according to an operating system, a predetermined computer program installed or downloaded, or the like; a ROM that stores an operating system, various computer programs, and the like, and functions as a storage unit that stores data necessary for the CPU to execute processing for each control; a RAM and a hard disk that store data necessary for the CPU to execute processing, and are also used as a work area in which information is appropriately rewritten by the CPU; an information input/output unit such as a communication interface; and the like, and these are connected by a necessary bus line.

A system of such a computer executes processing operations performed by the instantaneous current value determination device, the first alert notification information output unit, the power supply automatic interruptibility determination unit, the first power supply interruption device, the second power supply interruption device, the housing internal temperature monitoring unit, the electric path temperature monitoring unit, the second alert notification information output unit, the third alert notification information output unit, and the like described above.

The instantaneous current value determination device, the first alert notification information output unit, the power supply automatic interruptibility determination unit, the first power supply interruption device, the second power supply interruption device, the housing internal temperature monitoring unit, the electric path temperature monitoring unit, the second alert notification information output unit, the third alert notification information output unit, and the like described above do not need to be all disposed in one apparatus or device.

For example, a mode may be adopted in which an apparatus/device having some of these configurations is disposed in the power device, and this apparatus/device is connected to another apparatus/device disposed at a place away from the power device and including a computer having other configurations, so as to enable mutual communication of information via a wired or wireless network.

Alternatively, it is also possible to adopt a mode in which an apparatus/device having some of the configurations described above is disposed in the power device, and this apparatus/device is connected to another apparatus/device disposed at a place away from the power device and including a computer having some other configurations and is connected to another apparatus/device including a computer having remaining configurations among other configurations, so as to enable mutual communication of information via a wired or wireless network.

In the above, it is also possible to adopt a configuration in which a server computer disposed on a cloud is included in one or a plurality of other apparatuses/devices that are disposed at a place away from the power device, are connected via a wired or wireless network, and have some configurations or remaining configurations among other configurations described above.

### Example of Tracking Detection System in DESCON Emergency System>

The DESCON emergency system described above can include a tracking detection system described below.

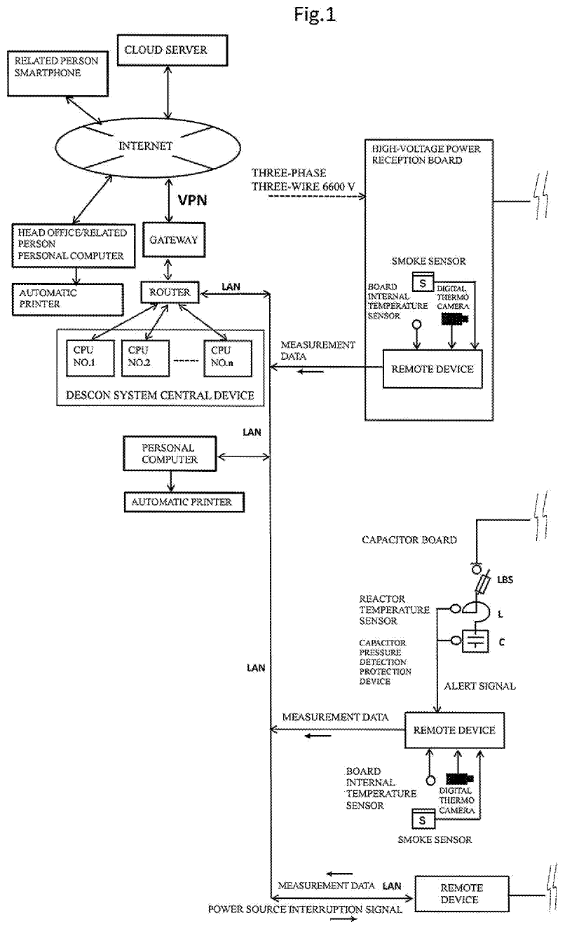

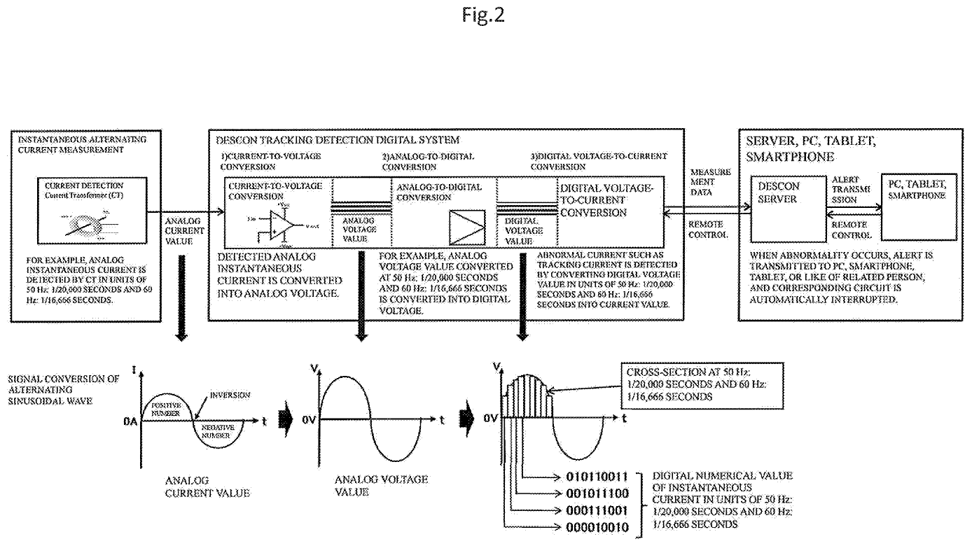

In this tracking detection system, as illustrated in FIGS. 2, 1) an analog instantaneous alternating current value detected by a current detection CT is converted into an analog voltage value, 2) the analog voltage value is converted into a digital voltage value, and 3) the digital voltage value is converted into a current value, and an abnormal current caused by sparking, tracking, or the like is detected.

The series of processing operations can be implemented by, for example, a microcontroller or a microprocessor in a form of a printed board.

In this tracking detection system, for example, a mode may be adopted in which a current at a frequency of 50 Hz is measured in 1/20,000 seconds, and a current at 60 Hz is measured in 1/16,666 seconds, a short-circuit current caused by sparking or a tracking phenomenon that occurs instantaneously is measured, and a large current of the sparking or the tracking is detected.

A mode may be adopted in which an instantaneous current is detected in units of 1/20,000 seconds at 50 Hz and 1/16,666 seconds at 60 Hz, the detected analog current value is converted into an analog voltage value, the converted analog voltage value is converted into a digital voltage value and is further converted into a current value, and an abnormal current caused by sparking, tracking, or the like is detected.

Such a tracking detection system can be referred to as a DESCON tracking detection digital system. The DESCON tracking detection digital system described above is a tracking detection system on an electric path through which an alternating current flows.

### Another Example of Tracking Detection System in DESCON Emergency System

The DESCON emergency system described above can include another tracking detection system described below.

In this tracking detection system, as illustrated in FIGS. 3, 1) an analog instantaneous direct current value detected by an instantaneous direct current measuring instrument is converted into an analog voltage value, 2) the analog voltage value is converted into a digital voltage value, and 3) the digital voltage value is converted into a current value, and an abnormal current caused by sparking, tracking, or the like is detected.

As illustrated in FIG. 3, as the instantaneous direct current measuring instrument, a Hall element detector, a flux gate detector, and other instantaneous direct current measuring instruments known in this technical field can be adopted.

The processing of converting the analog voltage value into the digital voltage value can be implemented by, for example, a microcontroller or a microprocessor in the form of a printed board.

In this tracking detection system, for example, a mode may be adopted in which a current is measured at 1/10,000 seconds to 1/100,000 seconds to 1/n seconds, a short-circuit current caused by sparking or a tracking phenomenon that occurs instantaneously is measured, and a large current of the sparking or the tracking is detected.

A mode may be adopted in which an instantaneous current is detected in units of 1/10,000 seconds to 1/100,000 seconds to 1/n seconds, the detected analog current value is converted into an analog voltage value, the converted analog voltage value is converted into a digital voltage value and is further converted into a current value, and an abnormal current caused by sparking, tracking, or the like is detected.

For example, the tracking detection system is for DC electrical equipment such as a motor for a railway or an electric vehicle, or a DC power source device such as a solar power generation system or a storage battery.

Such a tracking detection system can be referred to as a DESCON tracking detection digital system. The DESCON tracking detection digital system described above is a tracking detection system on an electric path through which a direct current flows.

### Example of Tracking Detection Function in DESCON Emergency System

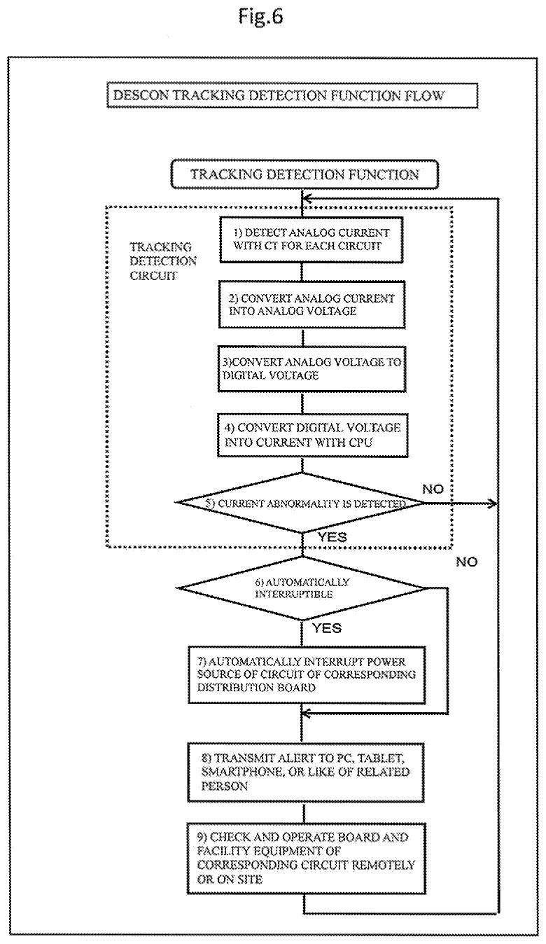

The DESCON emergency system may have a tracking detection function, an example of which is illustrated in FIG. 6. The tracking detection function can be achieved by the tracking detection system in the DESCON emergency system described above.

In this tracking detection function, an instantaneous current value detector (current transformer: CT) is installed in a corresponding circuit such as a switchboard, a distribution board, a control panel, or terminal equipment, and an analog current value detected by the CT in an instantaneous time is detected. Units of the instantaneous time in the analog current detection are within a range of, for example, 1 second/12,000 (83 μsec) to 1 second/ 50 000 (20 μsec). Further, for example, units of the instantaneous time may be within a range of 1 second/ 100,000 (10 μsec) to 1 second/N value in proportion to a performance of a PC.

Next, the analog current value is converted into an analog voltage value. For example, the analog current value detected in an instantaneous time within the range of 1 second/ 12,000 (83 μsec) to 1 second/50,000 (20 μsec), the range of 1 second/100,000 (10 μsec) to 1 second/N value (N μsec), or the like is converted into an analog voltage value.

Next, the analog voltage value is converted into a digital voltage value. That is, the converted analog voltage value is A/D converted into a digital voltage.

Next, the digital voltage value converted as described above is converted into a current value.

Next, on the basis of the current value converted as described above, an abnormal current is detected and determined.

For example, an instantaneous current value with a surge factor of 30 to 100 times an allowable current value is detected and determined as an abnormal current caused by a short circuit, sparking, or a tracking phenomenon of the corresponding circuit.

The above-described processing operations can be implemented by, for example, a microcontroller or a microprocessor in a form of a printed board. In addition, the processing may be executed by the CPU of the computer.

When a current abnormality is detected in the above-described processing and automatic interruption is possible, a power source that is supplying power to a circuit of the corresponding distribution board is automatically interrupted.

In addition, an alert is transmitted to a PC, a tablet, a smartphone, or the like of a related person. This alert email can be transmitted many times until the related person confirms and resets the alert, so that safety measure for recovery can be performed after automatic interruption.

In addition, a board and facility equipment of the corresponding circuit can be checked and operated remotely or on site.

As described above, the tracking detection function, an example of which is illustrated in FIG. 6, provided to the DESCON emergency system is capable of thoroughly controlling and preventing electrical burnout and an electrical fire, by continuously transmitting an alert until the transmitted alert is confirmed and reset by a related person, in alert transmission and automatic interruption.

### Example of Joule Heat Detection Function in DESCON Emergency System>

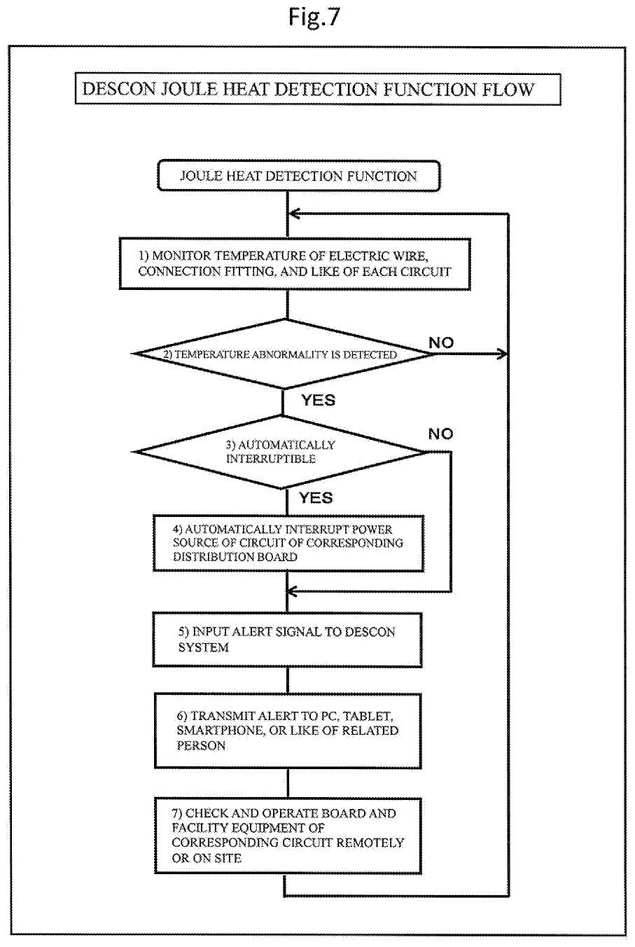

The DESCON emergency system may have a Joule heat detection function, an example of which is illustrated in FIG. 7.

In this Joule heat detection function, a temperature of a connection terminal block of each circuit in which a circuit breaker (breaker) is disposed is monitored. That is, a temperature sensor monitors a temperature rise due to Joule heat of the connection terminal block.

In the circuit in which the circuit breaker (breaker) is disposed, for example, a cable is assumed to be a cable for each temperature such as an IV/KIV allowable temperature of 60 degrees, a VVF allowable temperature of 60 degrees, a VCT allowable temperature of 60 degrees, an HIV allowable temperature of 75 degrees, a CV allowable temperature of 90 degrees, and an MLFC allowable temperature of 90 degrees. In this case, for example, a caution temperature freely determined in advance for the cable, the electric wire, or the like with reference to an allowable temperature of the electric wire or the like is used as determination information with respect to the allowable temperature. For example, a temperature obtained by adding 10 to 15 degrees or the like to the allowable temperature may be set and stored as a caution temperature in a database. When a temperature of each corresponding board, cable, circuit, or the like reaches the caution temperature, an audio, a numerical value, and an image may be transmitted as an alert to a PC, a tablet, or a smartphone of a related person.

For example, the temperature sensor detects a temperature abnormality caused by a temperature rise due to looseness, a gap, a deviation, or the like of the connection terminal block or the like.

When a temperature abnormality can be determined and the circuit of the corresponding distribution board is automatically interruptible, a power source of a circuit of the corresponding distribution board is automatically interrupted.

When the temperature rises to a predetermined temperature, it is possible to automatically interrupt a power source that supplies power to a circuit of the corresponding distribution board, detect and determine occurrence of sparking and a tracking phenomenon due to melting and burnout of an insulating coating that provides an electric insulation resistance for the corresponding cable, electric wire, and circuit, and prevent electrical burnout and an electrical fire accident.

In this case, an alert can be transmitted to a PC, a tablet, a smartphone, or the like of a related person. The alert notification sound may be played until the related person confirms and resets the alert, or multiple emails may be sent consecutively to cause repeated notification sound, to prevent failure to confirm by the related person.

In addition, a board and facility equipment of the corresponding circuit can be checked and operated remotely or on site.

As described above, the Joule heat detection function, an example of which is illustrated in FIG. 7, provided to the DESCON emergency system is capable of thoroughly controlling and preventing electrical burnout and an electrical fire, by continuously transmitting an alert until the transmitted alert is confirmed and reset by a related person, in the alert transmission and the automatic interruption.

### Example of Overcurrent Detection Function in DESCON Emergency System

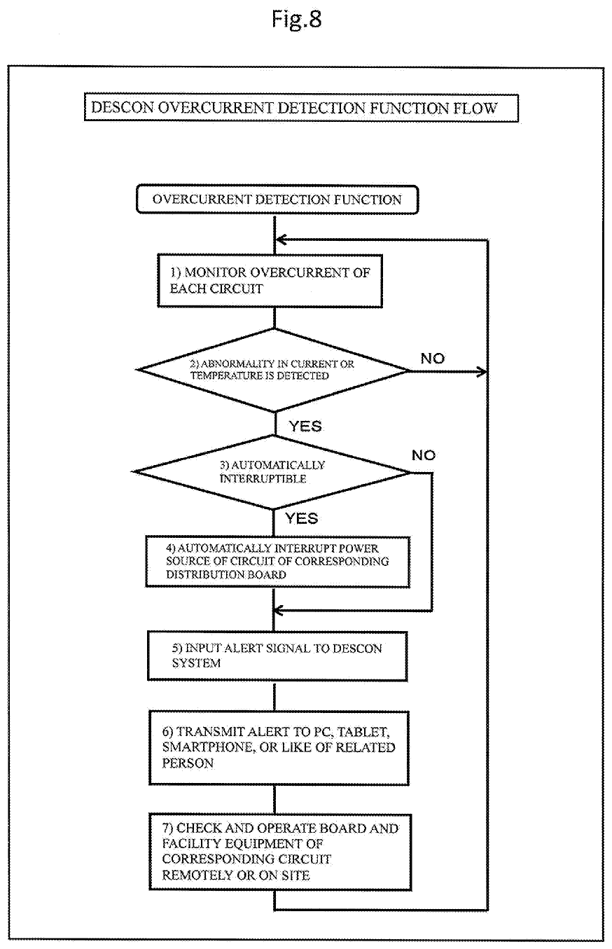

The DESCON emergency system may have an overcurrent detection function, an example of which is illustrated in FIG. 8.

In this overcurrent detection function, a current value of each circuit in which a circuit breaker (breaker) is disposed is monitored.

For example, an instantaneous current value detector (current transformer: CT) monitors an overcurrent of each circuit.

As an operation time of a breaker for each current value, for example, a protective breaking operation time of a breaker with a rated current value of 30 A is 60 minutes or less in a case of 37.5 A, which is 1.25 times a rated current value.

For example, when a wiring circuit breaker such as a breaker for protecting a circuit is not properly installed, an overcurrent occurs in the circuit and the current increases, so that heat generation of an electric wire greatly increases due to Joule heat. If this state continues, the electric wire rises to a high temperature, and an insulating material of the electric wire melts.

For example, it is possible to use, as determination information with respect to the allowable temperature, a caution temperature freely determined in advance for a switchboard, a distribution board, a junction box, connection equipment, terminal equipment, each facility equipment for connection, electrical equipment and instrument, the cable, the electric wire, or the like, with reference to an allowable temperature of a cable, an electric wire, or the like for each temperature such as an IV/KIV allowable temperature of 60 degrees, a VVF allowable temperature of 60 degrees, a VCT allowable temperature of 60 degrees, an HIV allowable temperature of 75 degrees, a CV allowable temperature of 90 degrees, and an MLFC allowable temperature of 90 degrees, for example. For example, a temperature obtained by adding 10 to 15 degrees to the allowable temperature is set and stored as a caution temperature in a database. When a temperature of each corresponding board, cable, circuit, or the like reaches the caution temperature, an audio, a numerical value, and an image are transmitted as an alert to a PC, a tablet, or a smartphone of a related person.

An instantaneous current value detector (current transformer: CT) is installed for each of the circuits, an abnormality in current value is detected, and a temperature rise of a cable, an electric wire, a connection fitting, or the like is detected by a temperature sensor.

When an abnormality in current or temperature is detected and automatic interruption is possible, a power source of a circuit of the corresponding distribution board is automatically interrupted.

When the temperature rises to a predetermined temperature, it is possible to automatically interrupt the power source of the circuit of the corresponding distribution board, for example, detect and determine occurrence of sparking and a tracking phenomenon due to melting and burnout of an insulating coating that provides an electric insulation resistance for the corresponding cable, electric wire, and circuit, and prevent electrical burnout and an electrical fire accident.

In this case, an alert is transmitted to a PC, a tablet, a smartphone, or the like of a related person. The alert notification sound may be played until the related person confirms and resets the alert, or multiple emails may be sent consecutively to cause repeated notification sound, to prevent failure to confirm by the related person.

A board and facility equipment of the corresponding circuit can be checked and operated remotely or on site.

As described above, the overcurrent detection function, an example of which is illustrated in FIG. 8, provided to the DESCON emergency system is capable of thoroughly controlling and preventing electrical burnout and an electrical fire, by continuously transmitting an alert until the transmitted alert is confirmed and reset by a related person, in the alert transmission and the automatic interruption.

### Example of Leakage Current Detection Function in Descon Emergency System

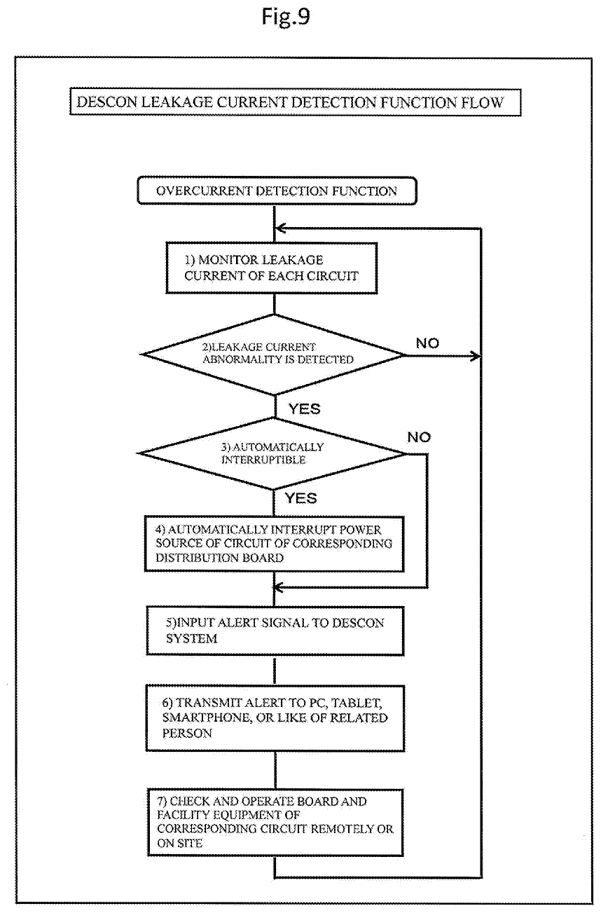

The DESCON emergency system may have a leakage current detection function, an example of which is illustrated in FIG. 9.

In this leakage current detection function, a leakage current of each circuit in which a circuit breaker (breaker) is disposed is monitored by a leakage current value detector (zero-phase current transformer: ZCT).

When an abnormality in leakage current of a circuit is detected by the ZCT, for example, when a predetermined leakage current value is reached and the circuit is automatically interruptible, a power source that is supplying power to a circuit of the corresponding distribution board is automatically interrupted. For example, it is possible to detect and determine an insulation failure due to aging of a corresponding cable, electric wire, and circuit, and to prevent electrical burnout, an electrical fire accident, and an electric shock accident.

When a leakage current value detected by the ZCT reaches a caution current value, an audio, a numerical value, and an image may be transmitted as an alert to a PC, a tablet, and a smartphone of a related person. The alert notification sound may be played until the related person confirms and resets the alert, or multiple emails may be sent consecutively to cause repeated notification sound, to prevent failure to confirm by the related person.

A board and facility equipment of the corresponding circuit can be checked and operated remotely or on site.

As described above, the leakage current detection function, an example of which is illustrated in FIG. 9, provided to the DESCON emergency system is capable of thoroughly controlling and preventing electrical burnout and an electrical fire, by continuously transmitting an alert until the transmitted alert is confirmed and reset by a related person, in the alert transmission and the automatic interruption.

### Example of Breaker System in DESCON Emergency System

The DESCON emergency system described above can include a breaker system described below.

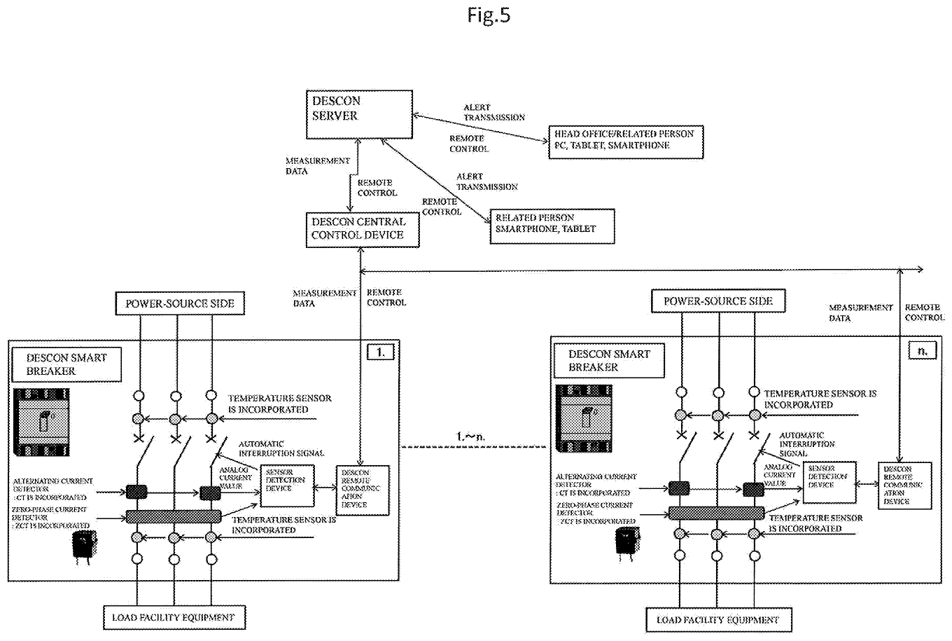

As an example is illustrated in FIG. 5, the breaker system is a system that incorporates, into a wiring circuit breaker (breaker), the tracking detection function, the Joule heat detection function, the overcurrent detection function, the leakage current detection function, and the automatic interruption function described above in the DESCON emergency system, to prevent an electrical fire and a burnout accident.

The current transformer (CT) in the tracking detection function and the overcurrent detection function described above, the temperature sensor in the Joule heat detection function described above, and the leakage current value detector (zero-phase current transformer: ZCT) in the leakage current detection function described above are all incorporated in the circuit breaker (breaker).

Accordingly, this breaker system detects tracking, Joule heat, an overcurrent, a leakage current, and the like, for example, for each main breaker (wiring circuit breaker) of each circuit of a switchboard, a distribution board, a control panel, electrical equipment, a load device, and the like, and transmits an alert by an audio, an image, and the like to a PC, a tablet, a smartphone, or the like of a related person, when the breaker system detects a predetermined abnormal numerical value of the tracking current, the temperature, the overcurrent, or the leakage current.

In addition, when a predetermined alert current, alert temperature, or alert leakage current is detected, an alert is transmitted to a PC, a tablet, a smartphone, or the like of a related person by an audio, an image, and the like, and the corresponding circuit or main breaker can be brought into an automatic interruption mode.

Such a breaker system may be referred to as a DESCON smart breaker system, as illustrated in FIG. 5.

Although the embodiment of the present invention has been described above with reference to the accompanying drawings, the present invention is not limited to the above-described embodiment, and various modifications can be made within the technical scope understood from the description of the claims.

1. A digital emergency electric safety control system comprising:
a power device in which a power-source-side electric path that is an electric path from a power-source side is electrically connected to a load-side electric path that is an electric path toward a load, via electrical equipment disposed in a housing;
an instantaneous current value detection device that is connected to the electric path and detects an instantaneous alternating current value or an instantaneous direct current value each of which is an instantaneous current value flowing through the electric path in an instantaneous time;
an instantaneous current value determination device that compares the detected instantaneous current value with a preset allowable current value range;
a first alert notification information output unit that outputs alert notification information together with information for specifying the power device related to the housing, to an administrator terminal used by an administrator who manages the power device and an operator terminal owned by an operator who is in charge of management of the power device, when the instantaneous current value determination device determines that the instantaneous current value is within a predetermined alert trigger range;
a power supply automatic interruptibility determination unit that determines, when the instantaneous current value determination device determines that the instantaneous current value is within a predetermined power supply interruption range, whether or not the load supplied with a current having the instantaneous current value determined to be within the predetermined power supply interruption range is an automatically interruptible power supply load;
a first power supply interruption device that automatically interrupts power supply to the load determined as an automatically interruptible power supply load by the power supply automatic interruptibility determination unit, and
a second power supply interruption device that interrupts, when the power supply automatic interruptibility determination unit determines that the load is not an automatically interruptible power supply load, power supply to a load device controller controlling the load determined as not being an automatically interruptible power supply load, and then automatically interrupts power supply to the load.

2. The digital emergency electric safety control system according to claim 1, wherein the instantaneous time is any given microsecond time between 1/50,000 seconds (=20 μsec) and 1/100,000 seconds (=10 μsec).

3. The digital emergency electric safety control system according to claim 1, further comprising:
a housing internal temperature information acquisition unit that constantly detects a temperature in the housing, and outputs, as digital information, housing internal temperature information that is information regarding the detected temperature in the housing, together with information for specifying the power device related to the housing;
an electric path temperature information acquisition unit that constantly detects a temperature of the electric path, and outputs, as digital information, electric path temperature information that is information regarding the detected temperature of the electric path together with information for specifying the electric path where the temperature has been detected;
a housing internal temperature monitoring unit that compares the temperature in the housing acquired by the housing internal temperature information acquisition unit with a housing internal monitoring temperature that is preset;
an electric path temperature monitoring unit that compares the temperature of the electric path acquired by the electric path temperature information acquisition unit with an electric path monitoring temperature that is preset;
a second alert notification information output unit that outputs alert notification information to the administrator terminal and the operator terminal together with information for specifying the power device related to the housing, when the housing internal temperature monitoring unit determines that the temperature in the housing acquired by the housing internal temperature information acquisition unit exceeds the housing internal monitoring temperature; and
a third alert notification information output unit that outputs alert notification information to the administrator terminal and the operator terminal, together with information for specifying the electric path having the temperature determined to exceed the electric path monitoring temperature, when the electric path temperature monitoring unit determines that the temperature of the electric path acquired by the electric path temperature information acquisition unit exceeds the electric path monitoring temperature.

4. The digital emergency electric safety control system according to claim 1, having a tracking detection function of detecting an abnormal current by converting an analog instantaneous alternating current value or an analog instantaneous direct current value detected by the instantaneous current value detection device into an analog voltage value, converting the analog voltage value into a digital voltage value, and converting the digital voltage value into a current value.

5. The digital emergency electric safety control system according to claim 1, having a Joule heat detection function by further comprising a temperature sensor that monitors a temperature rise due to Joule heat of a connection terminal block in the electric path where a circuit breaker (breaker) is disposed.

6. The digital emergency electric safety control system according to claim 1, having an overcurrent monitoring function of monitoring, by the instantaneous current value detection device, an overcurrent in the electric path where a circuit breaker (breaker) is disposed.

7. The digital emergency electric safety control system according to claim 1, having a leakage current monitoring function by further comprising a leakage current value detector (zero-phase current transformer: ZCT) that monitors a leakage current in the electric path where a circuit breaker (breaker) is disposed.

8. The digital emergency electric safety control system according to claim 5, wherein the circuit breaker (breaker) disposed on the electric path has the Joule heat detection function, the overcurrent monitoring function, and the leakage current monitoring function.
